(19) United States
(12) Patent Application Publication
(10) Pub. No.: US 2026/0081799 A1
(43) Pub. Date: Mar. 19, 2026

(54) BINDING SUPPORT FUNCTION CAPACITY EXPANSION

(71) Applicant: Oracle International Corporation, Redwood City, CA (US)

(72) Inventors: Rajiv Krishan, Cary, NC (US); Gaurav Paliwal, Acton, MA (US); Anup Shivarajapura, Bangalore (IN); Robert Michael Batz, Raleigh, NC (US)

(21) Appl. No.: 19/323,076

(22) Filed: Sep. 9, 2025

(30) Foreign Application Priority Data
Sep. 18, 2024 (IN) 202441070473

(51) Int. Cl. H04L 12/14; H04W 4/24; H04W 8/26

(52) U.S. Cl. CPC H04L 12/1407; H04W 4/24; H04W 8/26

(57) ABSTRACT

Various embodiments of the present technology generally relate to systems and methods for binding support function (BSF) capacity expansion. In some examples, a method may comprise operating a binding support function (BSF) of a mobile network, including determining whether an internet protocol (IP) address of a received message corresponds to a local IP address range, and when the IP address of the received message does not correspond to the local IP address range, accessing a first network function (NF) profile at a network repository function (NRF) to determine a second BSF corresponding to the IP address, and forwarding the received message to the second BSF.

### CROSS-REFERENCE TO RELATED APPLICATION

The present application claims priority under 35 USC § 119 and 37 CFR 1.55 to pending Indian provisional patent application, application No. 202441070473, filed Sep. 18, 2024, entitled “Binding Support Function Capacity Expansion”, the contents of which are hereby incorporated by reference in their entirety.

### TECHNICAL FIELD

Various embodiments of the present technology generally relate to management of service capacity within mobile networks, such as fifth generation (5G) communications networks. More specifically, embodiments of the present technology relate to systems and methods for improved capacity of binding support functions (BSF) within a network.

### BACKGROUND

In some communication network architectures, such as those using third generation partnership project (3GPP) standards, service may be implemented by establishing a user communication session. For example, a UE (User Equipment) may connect to an IP multimedia subsystem (IMS) by first establishing a PDU (packet data unit or protocol data unit) session. To support a voice or data call, a number of network functions (NFs) within a 5G network may work together to manage aspects of a session.

As part of the PDU session creation process, a policy control function (PCF) may be assigned to the session to generate policy rules for the session to control quality of service (QoS) and charging for the session. The PCF assigned to the session may register with a binding support function (BSF), and the BSF can create a binding record for the session in its database. The binding record can ensure that Rx protocol messaging for a certain PDU session can reach the relevant policy PCF having the PDU session information, or for nBSF discovery that allows an application function (AF) or network exposure function (NEF) to discover a PCF to use for N5 protocol communications. The BSF network function assigned to the session can comprise information such as N7 session parameters, N7 endpoint, and Diameter identity for a PCF instance, and a session linked to a function in this manner may be referred to as a binding session.

However, with increases in 4G to 5G transitions, customers may need higher BSF capacity to handle IMS (IP Multimedia Subsystem) flows. Higher capacity may mean the capability to handle more TPS (transactions per second), more binding records in a DB (database) of the BSF, as well as resources required to scale existing instances, etc. Any of these can be a limiting factor for BSF capacity expansion.

A network may include one or more BSF sets, each comprising multiple BSF instances that mirror context data between them, so that any BSF instance in the set can handle requests directed any other BSF instance in the set. As an added difficulty to BSF capacity expansion, if an IP address range (e.g., X to Z) managed by a given set of BSFs needs to be repartitioned (e.g., X to Y for set0, and Y+1 to Z for set1), it may be a challenge to migrate existing sessions from one set to another. One reason is that a PCF's binding may become invalid if the session migrates to another BSF set without updating the PCF's context data. Accordingly, there exists a need for improved processes for BSF capacity expansion, and for partitioning of BSF ranges at runtime.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for implementing binding support function (BSF) capacity expansion. In an embodiment, a BSF system may comprise one or more processors, and a memory having stored thereon instructions. The instructions, upon execution, may cause the one or more processors to determine whether an internet protocol (IP) address of a received message corresponds to a local IP address range, and when the IP address of the received message does not correspond to the local IP address range, access a first network function (NF) profile at a network repository function (NRF) to determine a second BSF corresponding to the IP address, and forward the received message to the second BSF.

In some embodiments, the BSF system may determine whether the IP address corresponds to the local IP address range, further including determine whether the IP address range corresponds to a current IP address range managed by the BSF, and determine whether the IP address range corresponds to a prior IP address range managed by the BSF. The BSF system may perform a local lookup for a binding record associated with the IP address when the IP address corresponds to the local IP address range. In some examples, the BSF system may forward the received message to a policy control function (PCF) based on the binding record. In some embodiments, the BSF system may publish an indication of the prior IP address range in response to partitioning the prior IP address range. The BSF system may publish the indication of the prior IP address range as a vendor specific attribute in a second NF profile associated with the BSF. In some examples, The BSF system may publish a timestamp corresponding to the prior IP address range in the vendor specific attribute. In some embodiments, the BSF system may access the first NF profile at the NRF to determine the second BSF corresponding to the IP address, further including determine whether the second BSF is presently configured to manage an address range that includes the IP address, and determine whether the second BSF was previously configured to manage an old address range that includes the IP address based on the vendor specific attribute of the first NF profile. The BSF system may determine a plurality of BSFs have old address ranges including the IP address range, and select the second BSF from the plurality of BSFs based on the second BSF having a most recent timestamp associated with the old address range. In some examples, the BSF system may determine when a max lifespan of any binding record associated with the prior IP address range has expired, and update the second NF profile to remove the prior IP address range when the max lifespan has expired.

In an alternative embodiment, a method may comprise operating a binding support function (BSF) of a mobile network, including determining whether an internet protocol (IP) address of a received message corresponds to a local IP address range, and when the IP address of the received message does not correspond to the local IP address range, accessing a first network function (NF) profile at a network repository function (NRF) to determine a second BSF corresponding to the IP address, and forwarding the received message to the second BSF.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 illustrates a computing system configured to perform binding support function capacity expansion, in accordance with some embodiments of the present technology;

FIG. 2 illustrates a computing system configured to perform binding support function capacity expansion, in accordance with some embodiments of the present technology;

FIG. 3 depicts a flow diagram of a system configured to implement binding support function capacity expansion, in accordance with certain embodiments of the present disclosure;

FIG. 4 depicts a flowchart of an example method to implement binding support function capacity expansion, in accordance with certain embodiments of the present disclosure; and

FIG. 5 illustrates a computing system configured to perform binding support function capacity expansion, in accordance with some embodiments of the present technology.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

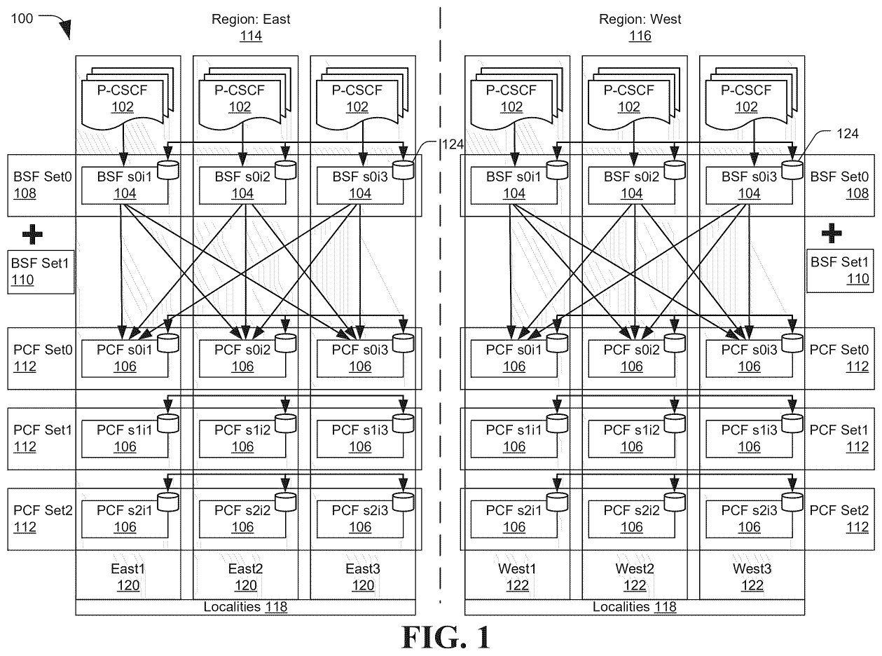

FIG. 1 is a diagram of a system 100 configured to perform binding support function capacity expansion, in accordance with certain embodiments of the present disclosure. The example system 100 may include a mobile network implementing 3GPP (3rd Generation Partnership Project) communication standards, although the present disclosure may apply to other communication networks. The network may include components found in 4G networks, 5G networks, or a combination thereof.

In particular, the system 100 may be an example of a deployment architecture for P-CSCFs (Proxy Call Session Control Function) 102, BSFs (Binding Support Function) 104, and PCFs (Policy Control Function) 106. The components of mobile network 100 may be spread across two or more regions, such as an East region 114 and West region 116, which may have their components further distributed across a plurality of localities 118, such as East localities 120 (East1, East2, and East3), and West localities 122 (West1, West2, and West3). A plurality of BSFs 104 may be grouped in a BSF set, such as BSF Set0 108, while PCFs 106 may be grouped into a plurality of PCF sets 112 (e.g., PCF Set 0, PCF Set1, and PCF Set2). In some examples, there may be an NF instance from each set 108, 112 located within each locality 118, such as instance 1 from each set in East1, instance 2 from each set in East2, and instance 3 from each set in East3. The distribution of components between regions 114, 116 and localities 118-122 may be to distribute load across components while providing users of the network with fast responses from geographically local network infrastructure.

As previously mentioned, a BSF 104 may maintain PDU (packet data unit or protocol data unit) session binding information, for example in a local database (DB) 124. A BSF 104 may maintain and provide the user identity, the DNN (domain name network), the UE (user equipment) addresses, and the PCF 106 address for the PDU session. A BSF 104 may ensure that an application function (AF) request for a certain PDU session can reach the relevant PCF 106 having the PDU session information.

BSFs 104 within a BSF set 108 may mirror their DB 124 records among all BSFs within the set, so if a BSF instance within the set becomes unavailable, another BSF instance in the set can handle the requests for the unavailable instance. In some deployments, a single BSF instance 104 can handle the entire capacity of its set 108 within a region 114, 116. In the depicted example of BSF Set0 108, there may be three BSF instances 104, such as s0i1 (set0, instance1), s0i2 (sct0, instance2), and s0i3 (set0, instance3). Each BSF instance 104 may create a mesh of Diameter (a messaging protocol) connections with PCF instances 106 in various sets 112 of its region 114, 116. In another example, Diameter connectivity between a BSF instance 104 and a PCF instance 106 in the region 114, 116 may be achieved via a relay connection via another BSF instance in the region.

As previously addressed, a PCF 106 may be assigned to a PDU session to generate policy rules for the session to control quality of service (QoS) and charging for the session. The PCF 106 assigned to the session may register with a BSF instance 104, and the BSF can create a binding record for the session in its database 124. The binding record can ensure that Rx protocol messaging for a certain PDU session can reach the relevant PCF 106 having the PDU session information, or allow for nBSF discovery messaging allowing AFs or NEFs to discover a PCF to be used for N5 communications. For convenience, the following descriptions may refer to Rx messaging, but the same teachings may be applied to nBSF discovery messaging.

As with BSF sets 108, PCFs 106 may be arranged in PCF sets 112, sharing similar set-instance nomenclature with the BSF sets 108 described above. Also similar to BSF sets 108, each PCF instance 106 within a PCF set 112 may have a database with its context data, which may be mirrored between PCF instances 106 in its own set 112.

A PCF 106 may have routing rules to select a BSF 104 for RAR (a Diameter re-authorization request) and ASR (a Diameter abort-session request) routing. The BSF 104 may perform routing of the requests based on a Destination-Host AVP (attribute value pair) to route to the corresponding P-CSCF 102.

A P-CSCF 102 may be a session initiation protocol (SIP) proxy that may be the first point of contact for user equipment in a mobile network 100. The P-CSCF 102 may act as the ingress and egress point to and from a service provider's IMS (internet protocol multimedia subsystem) domain with respect to an IMS client. SIP traffic to and from the user equipment may pass through the P-CSCF 102. The P-CSCF 102 may have a large number of responsibilities, including onward routing of registration and session requests to the correct nodes in the network 100, ensuring the S-CSCF (Serving CSCF, not shown) is kept updated on the access network the subscriber is using, providing session information to the PCRF (Policy and Charging Rules Function, not shown) and maintaining a secure connection with the client device.

A P-CSCF 102 may have the capability to connect with multiple BSF instances 104 as primary and secondary BSF contact points. For example, if a P-CSCF 102 receives an error code or cause when attempting to contact the primary BSF instance 104, it can route Rx request to a secondary or alternate BSF instance 104. However, a P-CSCF 102 may not have the capability to connect with BSF instances 104 based on conditional routing, e.g. based on a range of IP (e.g., IPv4 or IPv6) addresses supported by the BSF 104, nor may the P-CSCF 102 perform NRF (network repository function, not shown) discovery to find a BSF instance 104 for routing. An NRF may maintain an NF profile of available NF instances and their supported services. Consumer NFs can obtain information about producer NF instances that have registered with the NRF as a means of selecting an appropriate producer NF to receive a request from the consumer NF. However, a P-CSCF 102 may lack the capability to obtain NF producer information from an NRF.

In traditional network deployment architectures, a region 114, 116 may have a single BSF set 108 to handle the entire region. With the increase in 4G to 5G transitions, customers may need higher BSF 104 capacity to handle IMS flows. Capacity may mean more TPS (transactions per second), more binding records in their DBs 124, resources required to scale existing instances 104, etc. Any of these can be limiting factors for BSF capacity expansion. Horizontal or vertical scaling of BSF sets 108 may not be viable options due to DB 124 capacity concerns.

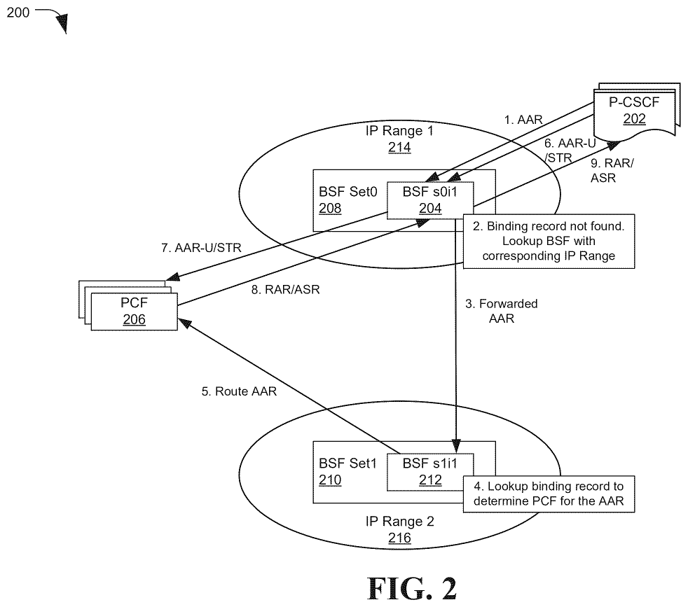

Greater BSF 104 capacity can be achieved by adding new BSF sets, such as BSF set1 110. However, if additional BSF set(s) are introduced, there may be no capability in AF or P-CSCFs 102 to determine which BSF set Rx requests should be sent to, e.g., BSF set0 108 or BSF set1 110. To handle the issue of routing messages to multiple BSF sets, a P-CSCF 102 may require NRF discovery support, which would require fresh development on P-CSCF 102 or DRA (Diameter routing agent, not shown, an element used in routing Diameter protocol messages). There may be no DRA or DSR (Diameter signaling router) between P-CSCF 102 and BSF 104, and adding such components may increase the cost of network deployment. An example system for expanding BSF capacity is described in regard to FIG. 2.

FIG. 2 is a diagram of a system 200 configured to perform binding support function capacity expansion, in accordance with certain embodiments of the present disclosure. In particular, the example system 200 may depict a configuration by which additional BSF sets may be added to a network architecture without requiring modifications at AFs or P-CSCFs. The system 200 may include one or more P-CSCF 202; a BSF Set0 208, including a BSF instance s0i1 204, supporting a first IP range 214; a BSF Set1 210, including a BSF instance s1i1 212, supporting a second IP range 216; and one or more PCFs 206. The elements of system 200 may correspond to the elements described in regard to FIG. 1.

To address the issue of adding BSF sets without custom implementation at P-CSCFs 202, new and existing BSF instances in a set may publish, in their NF profiles registered with an NRF, sliced ranges of an attribute supported by instances in the set; e.g., IP address or subnet, IP domain, etc. The attribute values may correspond to information available in an AAR (Authorization Authentication Request) message. An operator may ensure that the attribute ranges assigned to a BSF 104 do not overrun the BSF's TPS or DB capacity. In the example of system 200, the attribute may include an IP range, being split into IP range 1 214 and IP range 2 216. Using this technique, new attribute ranges may be added to existing or new BSF sets on demand.

When BSFs register a profile (referred to as an NF profile or BSF profile) with an NRF, the BSFs may make their profile discoverable to other BSFs. This may allow BSFs to learn about other BSF sets and their supported attribute range criteria. Rather than the P-CSCF 202 being configured to access multiple BSF sets, BSFs may be configured to function as a proxy to route messages to the appropriate BSF instance or set. BSFs may subscribe with the NRF to receive information about other BSF instances, and configure their Diameter router component with IP prefix and subnet-based proxy routing rules to corresponding BSF instances or sets.

A high-level process flow will be described based on the numbered transmissions and operations depicted in FIG. 2. At step 1, P-CSCF 202 may send an AAR message (e.g., an AAR-I, initial authorization authentication request) to its primary configured BSF instance, being BSF 204 of BSF set0 208, without regard to the supported IP range 1 214 of the BSF 204. The AAR message may include an IP prefix indicating which IP range the message falls within, IP range 1 214 or IP range 2 216. BSF 204 may examine the AAR message and its IP prefix. If the IP prefix is from the IP range 1 214 supported by the BSF 204, the BSF may perform a binding record lookup in its local DB to determine which PCF 206 to route the message to. In some embodiments, BSF 204 may attempt to look up the binding record even if the IP prefix of the AAR message does not match the BSF's current supported IP range (e.g., in case BSF 204 used to support the requested IP range and has the binding record, after which point the supported IP range was split into IP range 1 214 and IP range 2 216).

At operation 2, BSF 204 may determine that it does not have the binding record corresponding to the AAR message, or that the IP prefix of the AAR message does not fall within supported IP range 1 214. Accordingly, BSF 204 may look up which BSF instance or set supports the IP range for the IP prefix of the AAR message, either from BSF 204's own DB or by obtaining the information from an NRF. BSF 204 may determine that the appropriate target BSF for the AAR message is BSF 212 of BSF set1 210. At operation 3, BSF 204 may proxy or forward the AAR message to BSF 212.

Upon receiving the forwarded AAR message, BSF 212 may perform a binding record lookup for the appropriate PCF 206, at operation 4. BSF 212 may then route the AAR message to the appropriate PCF 205 based on the retrieved binding record, at operation 5. PCF 206 may process the AAR message, and may issue a response AAA message (not shown) back through BSF 212 that processed the AAR, which in turn may return the AAA through BSF 204 to P-CSCF 202. The response may include the PCF's 206 origin-host information, which may be received by the P-CSCF 202.

Accordingly, once the AAR-I routing completes, P-CSCF 202 can learn about PCF's 206 origin-host information, and can include it in subsequent messages for the session. At operation 6, P-CSCF 202 may send an AAR-U (authorization authentication request update) or STR (session termination request) message, with the PCF 206 identified in the destination-host information, to its primary BSF 204. BSF 204 may route the message directly to PCF 206 based on the destination-host information in the message, at operation 7, without needing to send the message to PCF 212.

Similarly, based on some stimulus on PCF 206, such as N7 protocol signaling from a session management function (SMF, not shown), PCF 206 may issue a RAR (re-authorization request) or ASR (abort-session request) message to P-CSCF 202, by way of example BSF 204, at operation 8. In a typical deployment, all BSFs may have Diameter peer connectivity to all P-CSCFs, so PCF 206 can send it to any BSF. Even if the selected BSF does not have direct connectivity, it may be able to relay the RAR/ASR to another BSF that does have peer connectivity. BSF 204 may forward the RAR/ASR message to P-CSCF 202, at operation 9.

The embodiment shown in system 200 may include a Diameter gateway deployed in every BSF instance of BSF set0 208, in order to handle the entire region's capacity for Rx flows. Accordingly, BSF Set0 208 may need more diameter gateway (DGW) pods (e.g., cloud computing elements) than other deployed BSF sets. In this embodiment, only BSF set0 208 needs to monitor BSF profiles of other BSF instances and sets within the region, and update its DGW configuration to select alternate BSF sets for AAR-I routing. This embodiment has BSF set0 208 acting as a centralized entity for Rx message routing between P-CSCF 202 and PCF 206. AAR-I messages may be routed to a respective BSF set that owns the appropriate IP range, while AAR-U or STR messages may be routed from the BSF set0 208 instance directly to PCF 206.

The proposed architecture of system 200 offers a number of advantages. It allows for scalability of BSF capacity, with range-based scoping of BSF sets allowing for the addition of new BSF sets for new ranges. System 200 provides resiliency, because splitting the DB capacity of BSFs in a region across multiple BSF sets can reduce a blast radius for DB failures. System 200 can minimize the impact to other NFs, with minimal impact to PCFs 206 as they dynamically adapt to changes in range by BSFs through NRF discovery and corresponding routing, and no impact on P-CSCF 202 routing or 3GPP-defined routing procedures. The system 200 architecture is compliant with 3GPP routing and NRF flows. System 200 also offers flexibility, with support for adding new IP ranges to existing BSF sets or new BSF sets in a region.

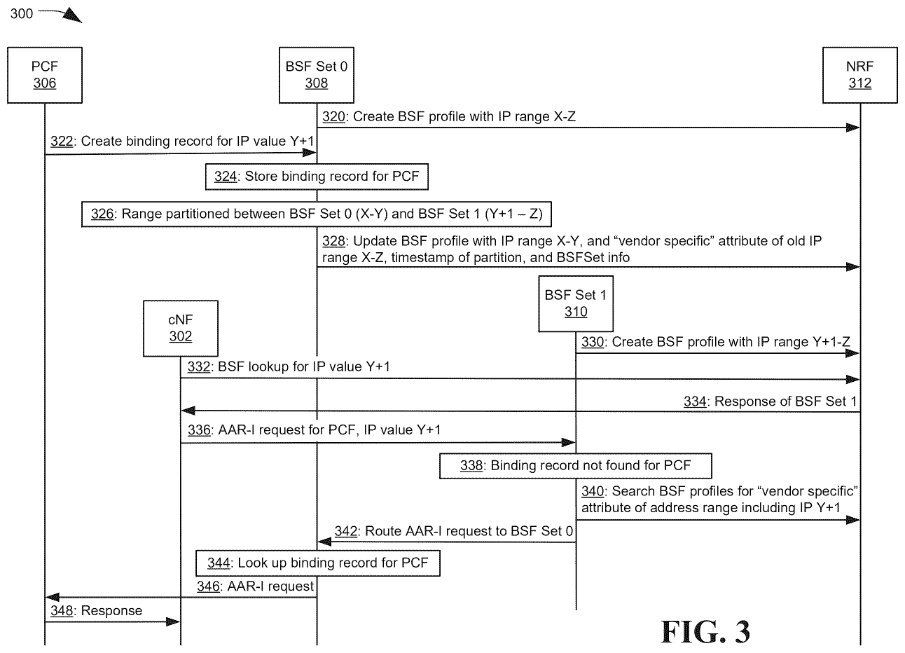

While adding new IP ranges via new BSF sets may not raise issues, difficulties can arise when splitting an IP range previously supported by a BSF set. For example, an operator may create a BSF set with a supported IP range of X-Z. Later, the operator may determine that the TPS/DB capacity of the set is insufficient to handle the entire X-Z range, and decides to repartition the range; e.g., X-Y for Set0 208, and Y+1-Z for Set1 210. The challenge that arises is that BSF sets cannot simply migrate PDU sessions from one BSF set to another. This may be because PCFs 206 bindings would become invalid if a session migrates to another BSF set without updating the PCF's context data. FIG. 3 provides a solution to performing BSF expansion with repartitioning of ranges and handling message routing at runtime.

FIG. 3 depicts a flow diagram 300 of a system configured to implement binding support function capacity expansion, in accordance with certain embodiments of the present disclosure. In particular, the diagram 300 may depict a process flow within a mobile communication network by which BSFs manage binding records with the possibility of having supported attribute ranges be repartitioned at runtime. Diagram 300 may depict an example message and processing flow between a PCF 306, BSF Set0 308, BSF Set1 310, NRF 312, and consumer network function (cNF) 302. An example cNF 302 may be a P-CSCF. The components in diagram 300 may correspond to elements described in regard to FIG. 1.

BSF Set0 308 may be deployed with a supported IP range of X-Z. At 320, BSF Set0 308 may register with NRF 312, creating a BSF profile that lists the supported IP range of X-Z, and makes the profile discoverable to other BSFs. At 322, PCF 306 may create a binding record with a BSF instance of BSF Set0 308, with the session having an associate IP value of Y+1. In response, BSF Set0 may store the binding record for PCF 306 to its local DBs, at 324.

At 326, an operator may partition the IP range of BSF Set0 308 into two segments, with BSF Set0 308 assigned the range X-Y, and BSF Set1 310 assigned the range of Y+1-Z. At 328, BSF Set0 308 may update its BSF profile(s) with the new supported IP range of X-Y, and add information to a “vendor specific” attribute field, listing the old supported IP range of X-Z, a timestamp for when the range was partitioned, and an identifier for BSF Set0 308. For example, BSF Set0 308 instances may add a field to their BSF profile listing:

```
″vendorSpecific-000111″: [{
  “timestamp″: <datetime>,
  “bsfInfo″: <older bsfInfo instance>,
  “bsfSet”: <BSF set identifier>
}]
```

Meanwhile, BSF Set1 310 may create a BSF profile with NRF 312 identifying its partitioned portion of the IP range, Y+1-Z, at 330.

New binding records created for PCFs at this point may be created at BSF Set0 308 or BSF Set1 310 based on the updated, partitioned IP range. However, updates to existing sessions may continue to happen with the BSF instance at which they were originally created, due to “location” and “binding” information provided by the BSF instance at the binding record creation time. In this example, PCF 306 created a binding record with BSF Set0 308, even though the associated IP value of Y+1 is now supported by BSF Set1 310.

At 332, a cNF 302 may optionally query NRF 312 to discover the BSF set providing service for IP value of Y+1, and NRF 312 may respond with information for BSF Set1 310, at 334. A cNF 302 may then map the BSF Set1 310 to one or more Rx peer connections that can be used to send the AAR-I request to BSF Set1 310, at 336.

When a BSF receives an AAR-I message, it may determine whether the associated IP range matches the BSFs supported IP range, or any old range criteria specified in the “vendor specific” attributes of its own profile, and if so, it may perform a local binding lookup. At 338, BSF Set1 310 may receive the AAR-I request from cNF 302, determine that the associated IP prefix of Y+1 matches the supported IP range of Y+1-Z, and may therefore perform a binding record lookup, but may fail to find an associated binding record (since the record is stored at BSF Set0 308). When the record is not found, or if the IP value of the AAR-I message does not match a current or previous IP range of BSF Set1 310, BSF Set1 310 may search BSF profiles from NRF 312 for any BSF Set that currently supports the appropriate IP range. As BSF Set1 310 already is the proper BSF Set for the IP value, BSF Set1 310 may next search the BSF profiles from NRF 312 for “vendor specific” attributes of prior address ranges including IP address Y+1, at 340. BSF Set1 310 may prioritize which BSF to target based on which has a matching old IP range in its “vendor specific” attributes with a most recent timestamp, in case there have been multiple repartitions performed recently. Based on the search, BSF Set1 310 may identify BSF Set0 308 as a potential holder of the appropriate binding record, and may route the AAR-I request to BSF Set0 309, at 342.

At 344, BSF Set0 308 may perform a binding record lookup based on the AAR-I message to identify the binding record for PCF 306. If BSF Set0 308 didn't have the record, it may search for another BSF that may have the record, as described above. To avoid “looping” between the same BSF set(s) but different BSF instance(s), when forwarding the request, the source BSF instance shall add its own “BSFSet” AVP with its bsfset information. Thus, before BSF-to-BSF routing, a BSF instance may avoid “BSF sets”, that have already been iterated for lookup. In another example, BSFSet information of an instance may be stored in the “vendor specific” attribute field along with their old IP address range(s), and a current BSF instance may avoid forwarding a message to a BSFset that has already been iterated to.

When BSF Set0 308 does find the binding record for PCF 306, it may forward the AAR-I request to PCF 306, at 346. In some embodiments, BSF Set0 308 may instead return details for PCF 306 to cNF 302, so that it may then message PCF 306 directly. At 348, PCF 306 may issue a response to cNF 302.

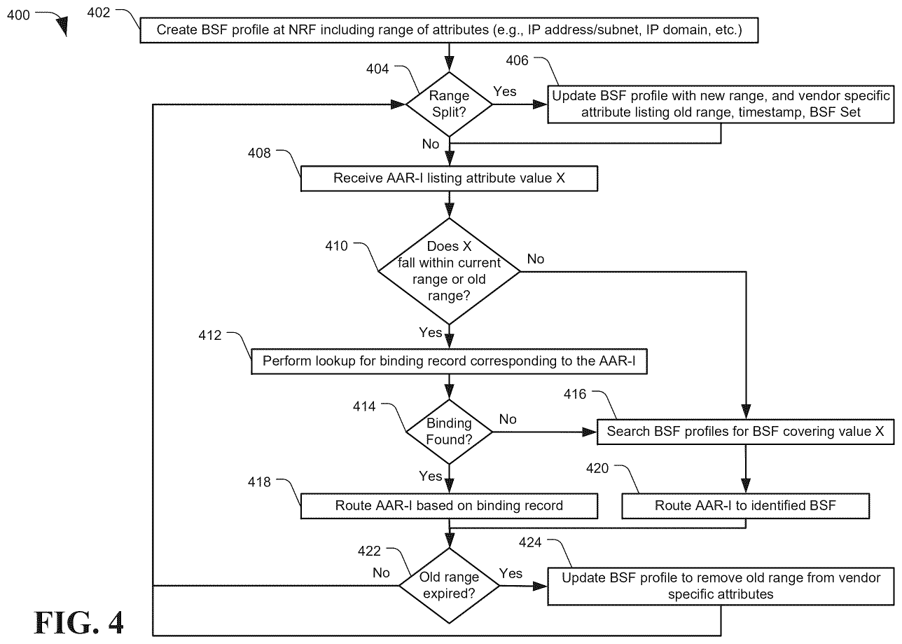

Binding sessions may have a maximum lifespan configured by an operator for any N7 communication protocol sessions that require binding at a BSF. Accordingly, BSFs may remove their old supported IP ranges from the “vendor specific” attribute field of their BSF profile after waiting for a period greater than the max lifespan, as there should no longer be any valid binding records for the old range retained at the BSF at that point. An example method for BSF capacity expansion is described in regard to FIG. 4.

FIG. 4 depicts a flowchart 400 of an example method to implement binding support function capacity expansion, in accordance with certain embodiments of the present disclosure. In particular, flowchart 400 depicts an example process by which BSFs may manage identifying a target BSF having an appropriate binding record after a supported IP range partition. The method of flowchart 400 may be executed by a BSF instance, such as BSF 104 of FIG. 1.

At 402, the method may include creating a BSF profile at an NRF, including a range of attributes supported by the BSF (e.g., IP address/subnet, IP domain, etc.). The BSF profile may be made discoverable by other BSF instances. At 404, the method may include determining whether the BSF's supported attribute range has been split or repartitioned. If yes, the method may include updating the BSF profile with the new supported range, and adding vendor specific attributes listing the old range, a timestamp of the partition, and potentially BSF set information.

If the supported range has not been split, at 404, or once the BSF profile has been updated, at 406, the method may include receiving an AAR-I message, having an attribute value of “X”, at 408. The method may include determining whether “X” falls within the current supported range, or a previously supported range, of the BSF, at 410. If so, the method may include performing a local lookup for the binding record corresponding to the AAR-I message, at 412. At 414, a determination may be made whether the binding record was found. If the binding record was found, the method may include routing the AAR-I message based on the binding record, at 418.

However, if the binding was not found, at 414, or if “X” does not fall within a current or previously supported range of the BSF, at 410, the method may include searching BSF profiles for a BSF currently or previously supporting an attribute range including “X”, with most recent support tried first (e.g., currently supported range, followed by a prior range with a most recent timestamp, etc.), at 416. At 420, the method may include routing the AAR-I message to the identified BSF instance.

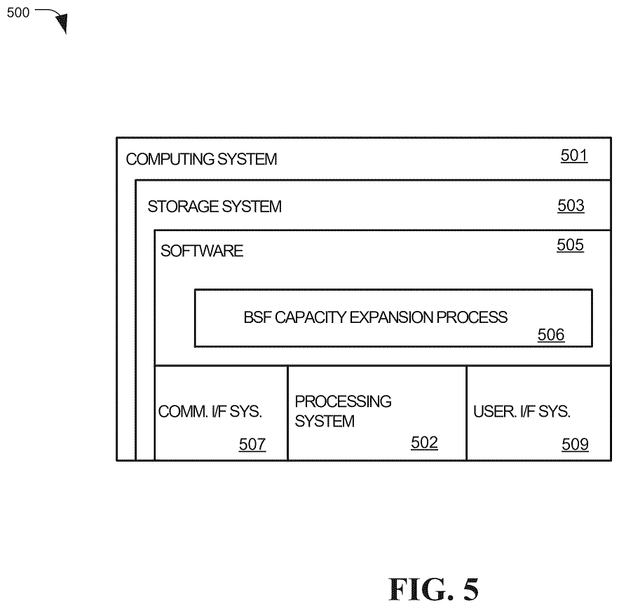

After the AAR-I message has been routed to an appropriate destination, at 418 or 420, the method may include determining whether any old range listed in the current BSF's profile has expired (e.g., is older than a maximum lifespan of any associated PDU session), at 422. If so, the method may include updating the BSF profile to remove the old range from the vendor specific attributes, at 424. If the old range(s) has not expired, at 422, or after updating the BSF profile, at 424, the method may return to monitoring for splits to the supported range, at 404, or receiving new AAR-I message, at 408. FIG. 5 depicts an exemplary system from performing binding support function capacity expansion.

FIG. 5 illustrates an apparatus 500 including a computing system 501 that is representative of any system or collection of systems in which the various processes, systems, programs, services, and scenarios disclosed herein may be implemented. For example, computing system 501 may be an example of a UE (user equipment), BSF (binding support function), PCF (policy control function), NRF (NF repository function), P-CSCF (Proxy Call Session Control Function), or other systems disclosed herein. Examples of computing system 501 include, but are not limited to, desktop computers, laptop computers, server computers, routers, web servers, cloud computing platforms, and data center equipment, as well as any other type of physical or virtual server machine, physical or virtual router, container, and any variation or combination thereof.

Computing system 501 may be implemented as a single apparatus, system, or device or may be implemented in a distributed manner as multiple apparatuses, systems, or devices. Computing system 501 may include, but is not limited to, processing system 502, storage system 503, software 505, communication interface system 507, and user interface system 509. Processing system 502 may be operatively coupled with storage system 503, communication interface system 507, and user interface system 509.

Processing system 502 may load and execute software 505 from storage system 503. Software 505 may include and implement BSF capacity expansion process 506, which may be representative of any of the operations for publishing managed ranges for a BSF in its NF profile, posting previous managed ranges based on partitioning, subscribing to or accessing other BSF NF profiles to determine managed ranges, and forwarding or proxying messages to an appropriate BSF, as discussed with respect to the previous figures. When executed by processing system 502, software 505 may direct processing system 502 to operate as described herein for at least the various processes, operational scenarios, and sequences discussed in the foregoing implementations. Computing system 501 may optionally include additional devices, features, or functionality not discussed for purposes of brevity.

In some embodiments, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 may include general purpose central processing units, graphical processing units, application specific processors, and logic devices, as well as any other type of processing device, combinations, or variations thereof.

Storage system 503 may comprise any memory device or computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (including BSF capacity expansion process 506 among other functions) may be implemented in program instructions that may, when executed by processing system 502, direct processing system 502 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system customized to implement the systems and processes as described herein. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” “including,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. Except when used for the selection or determination between alternatives, the word “or” in reference to a list of two or more items covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A binding support function (BSF) system, comprising:
one or more processors; and
a memory having stored thereon instructions that, upon execution by the one or more processors, cause the one or more processors to:
determine whether an internet protocol (IP) address of a received message corresponds to a local IP address range;
when the IP address of the received message does not correspond to the local IP address range,
access a first network function (NF) profile at a network repository function (NRF) to determine a second BSF corresponding to the IP address; and
forward the received message to the second BSF.

2. The BSF system of claim 1, wherein the instructions comprise further instructions that, upon execution by the one or more processors, cause the one or more processors to:
determine whether the IP address corresponds to the local IP address range includes:
determine whether the IP address range corresponds to a current IP address range managed by the BSF; and
determine whether the IP address range corresponds to a prior IP address range managed by the BSF.

3. The BSF system of claim 2, wherein the instructions comprise further instructions that, upon execution by the one or more processors, cause the one or more processors to:
perform a local lookup for a binding record associated with the IP address when the IP address corresponds to the local IP address range.

4. The BSF system of claim 3, wherein the instructions comprise further instructions that, upon execution by the one or more processors, cause the one or more processors to:
forward the received message to a policy control function (PCF) based on the binding record.

5. The BSF system of claim 4, wherein the instructions comprise further instructions that, upon execution by the one or more processors, cause the one or more processors to:
publish an indication of the prior IP address range in response to partitioning the prior IP address range.

6. The BSF system of claim 5, wherein the instructions comprise further instructions that, upon execution by the one or more processors, cause the one or more processors to:
publish the indication of the prior IP address range as a vendor specific attribute in a second NF profile associated with the BSF.

7. The BSF system of claim 6, wherein the instructions comprise further instructions that, upon execution by the one or more processors, cause the one or more processors to:
publish a timestamp corresponding to the prior IP address range in the vendor specific attribute.

8. The BSF system of claim 7, wherein the instructions comprise further instructions that, upon execution by the one or more processors, cause the one or more processors to:
access the first NF profile at the NRF to determine the second BSF corresponding to the IP address, further including:
determine whether the second BSF is presently configured to manage an address range that includes the IP address; and
determine whether the second BSF was previously configured to manage an old address range that includes the IP address based on the vendor specific attribute of the first NF profile.

9. The BSF system of claim 8, wherein the instructions comprise further instructions that, upon execution by the one or more processors, cause the one or more processors to:
determine a plurality of BSFs have old address ranges including the IP address range; and
select the second BSF from the plurality of BSFs having a most recent timestamp associated with the old address range.

10. The BSF system of claim 9, wherein the instructions comprise further instructions that, upon execution by the one or more processors, cause the one or more processors to:
determine when a max lifespan of any binding record associated with the prior IP address range has expired; and
update the second NF profile to remove the prior IP address range when the max lifespan has expired.

11. A method comprising:
operating a binding support function (BSF) of a mobile network, including:
determining whether an internet protocol (IP) address of a received message corresponds to a local IP address range;
when the IP address of the received message does not correspond to the local IP address range,
accessing a first network function (NF) profile at a network repository function (NRF) to determine a second BSF corresponding to the IP address; and
forwarding the received message to the second BSF.

12. The method of claim 11 further comprising:
determining whether the IP address corresponds to the local IP address range includes:
determining whether the IP address range corresponds to a current IP address range managed by the BSF; and
determining whether the IP address range corresponds to a prior IP address range managed by the BSF.

13. The method of claim 12 further comprising:
performing a local lookup for a binding record associated with the IP address when the IP address corresponds to the local IP address range.

14. The method of claim 13 further comprising:
forwarding the received message to a policy control function (PCF) based on the binding record.

15. The method of claim 11 further comprising:
in response to partitioning a prior IP address range managed by the BSF, publishing an indication of the prior IP address range.

16. The method of claim 15 further comprising:
publishing the indication of the prior IP address range as a vendor specific attribute in a second NF profile associated with the BSF.

17. The method of claim 16 further comprising:
publishing a timestamp corresponding to the prior IP address range in the vendor specific attribute.

18. The method of claim 17 further comprising:
accessing the first NF profile at the NRF to determine the second BSF corresponding to the IP address includes:
determining whether the second BSF is presently configured to manage an address range that includes the IP address; and
determining whether the second BSF was previously configured to manage an old address range that includes the IP address based on the vendor specific attribute of the first NF profile.

19. The method of claim 18 further comprising:
determining a plurality of BSFs have old address ranges including the IP address range; and
selecting the second BSF from the plurality of BSFs having a most recent timestamp associated with the old address range.

20. The method of claim 16 further comprising:
determining when a max lifespan of any binding record associated with the prior IP address range has expired; and
updating the second NF profile to remove the prior IP address range when the max lifespan has expired.
